(19) United States
(12) Patent Application Publication
(10) Pub. No.: US 2014/0074753 A1
(43) Pub. Date: Mar. 13, 2014

(54) ADJUSTMENT TOOL FOR MANAGING AND TRACKING A COLLECTION OF ASSETS

(71) Applicants: Eric William Weiske, Highland Village, TX (US); Brian Todd Weiske, Mission Viejo, CA (US)

(72) Inventors: Eric William Weiske, Highland Village, TX (US); Brian Todd Weiske, Mission Viejo, CA (US)

(21) Appl. No.: 14/025,226

(22) Filed: Sep. 12, 2013

Related U.S. Application Data
(60) Provisional application No. 61/700,269, filed on Sep. 12, 2012.

(51) Int. Cl. G06Q 40/06

(52) U.S. Cl. CPC G06Q 40/06
USPC 705/36 R

(57) ABSTRACT

Disclosed herein is an adjustment tool for managing a collection of assets and a method of customizing established percentages of segments that constitute a collection of assets. In one embodiment, the adjustment tool includes: (1) an interface configured to receive manipulation data associated with at least one of multiple segments that form the collection, wherein the multiple segments constitute the collection according to established percentages; and (2) a decision engine configured to generate a modified percentage of the at least one of the multiple segments based on the manipulation data, wherein the modified percentage differs from an established percentage of the at least one.

### CROSS REFERENCE TO RELATED APPLICATION

This application claims the benefit of U.S. Provisional Patent Application Ser. No. 61/700,269 filed on Sep. 12, 2012, by Eric William Weiske, entitled “AN ADJUSTMENT TOOL FOR MANAGING AND TRACKING DATA” and incorporated herein by reference in its entirety.

### TECHNICAL FIELD

This application is directed, in general, to managing data and, more specifically, to managing a collection of assets.

### BACKGROUND

A collection of items or data is often divided into related sections, segments, sectors, etc. As such, a user can more clearly see the content and make-up of the entire collection. For example, the items of an auto parts store can be divided into different categories such as brakes, mufflers, wheels, etc. Additionally, a market index is divided into categories such as oil and gas, manufacturing, telecom, etc.

### SUMMARY

In one aspect the disclosure provides an adjustment tool for managing a collection of assets. In one embodiment, the adjustment tool includes: (1) an interface configured to receive manipulation data associated with at least one of multiple segments that form the collection, wherein the multiple segments constitute the collection according to established percentages; and (2) a decision engine configured to generate a modified percentage of the at least one of the multiple segments based on the manipulation data, wherein the modified percentage differs from an established percentage of the at least one.

In another aspect, the disclosure provides a method of customizing established percentages of segments that constitute a collection of assets. In one embodiment, the method includes: (1) receiving manipulation data associated with at least one of the segments, (2) generating a modified percentage for the at least one of the segments according to the manipulation data, wherein the modified percentage differs from an established percentage of the at least one and (3) customizing a composition of the collection according to the modified percentage.

In yet another aspect, the disclosure provides an adjustment tool for managing a market index. In one embodiment, the adjustment tool includes: (1) an interface configured to receive manipulation data associated with a sector of the market index and (2) a decision engine configured to generate a customized composition of the market index by modifying a recognized weight of the sector according to the manipulation data, wherein the customized composition differs from a recognized composition of the market index.

### BRIEF DESCRIPTION

Reference is now made to the following descriptions taken in conjunction with the accompanying drawings, in which:

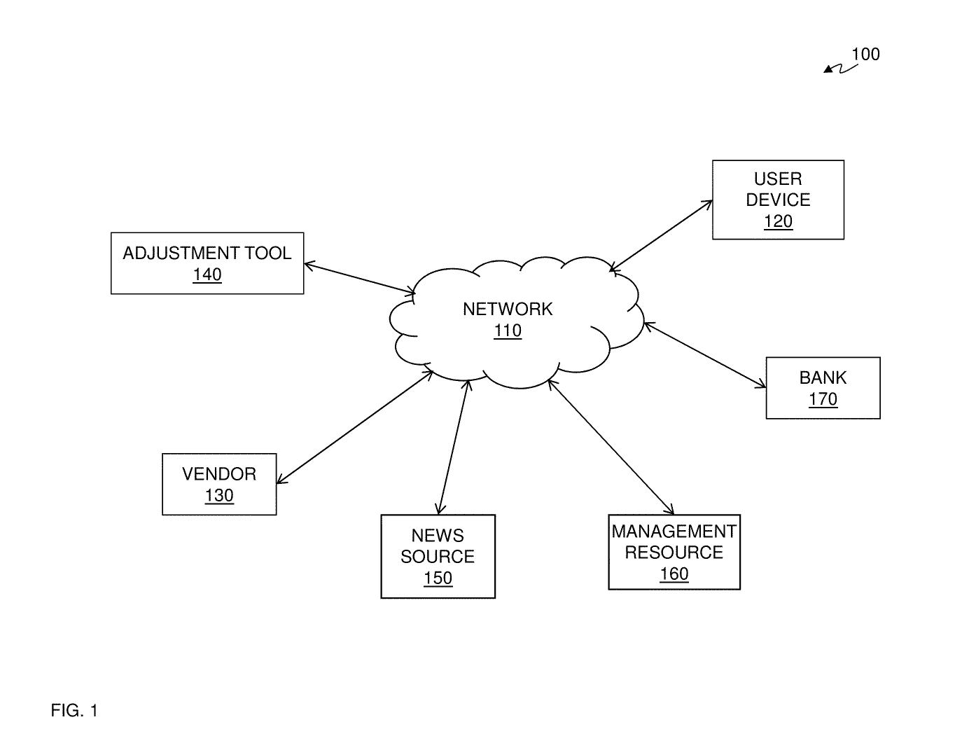

FIG. 1 illustrates a diagram of an embodiment of a management system constructed according to the principles of the disclosure;

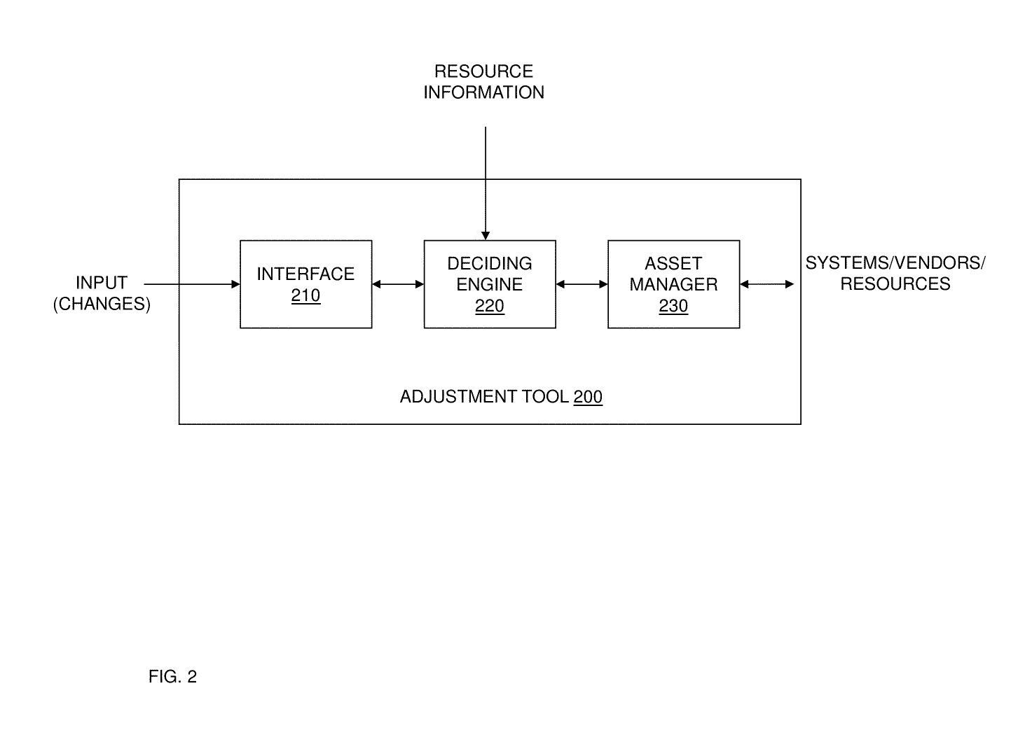

FIG. 2 illustrates a block diagram of an embodiment of an adjustment tool constructed according to the principles of the disclosure;

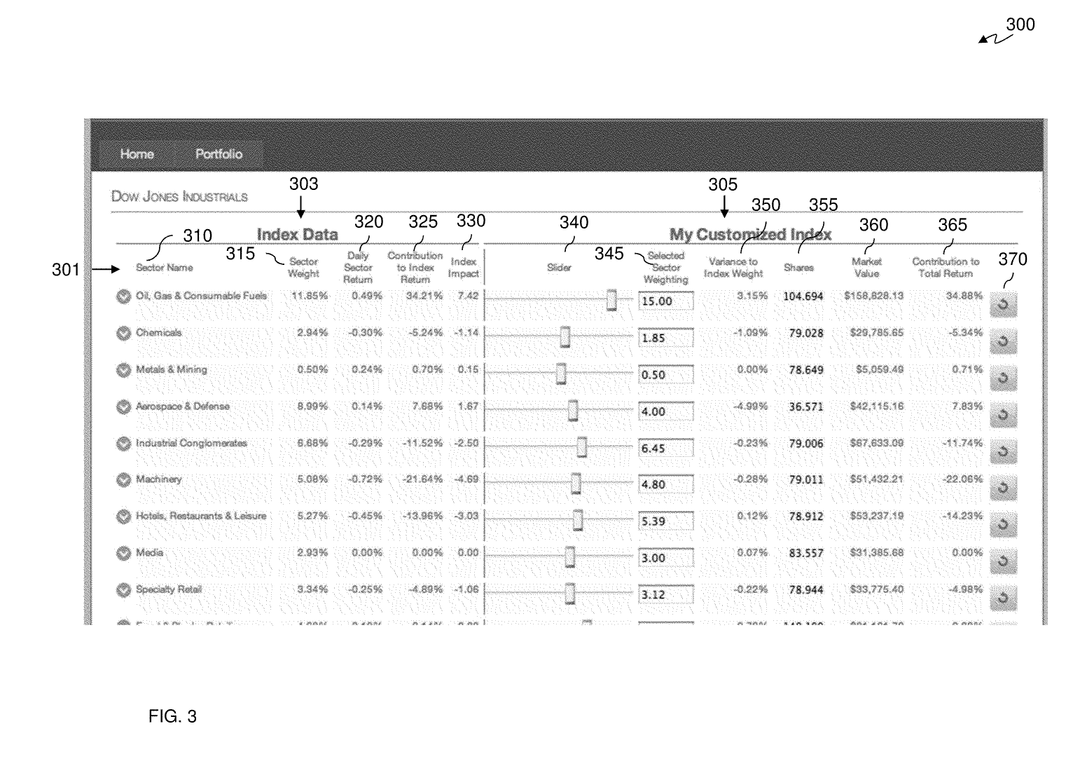

FIG. 3 illustrates a screen shot of an embodiment of an interface constructed according to the principles of the disclosure; and

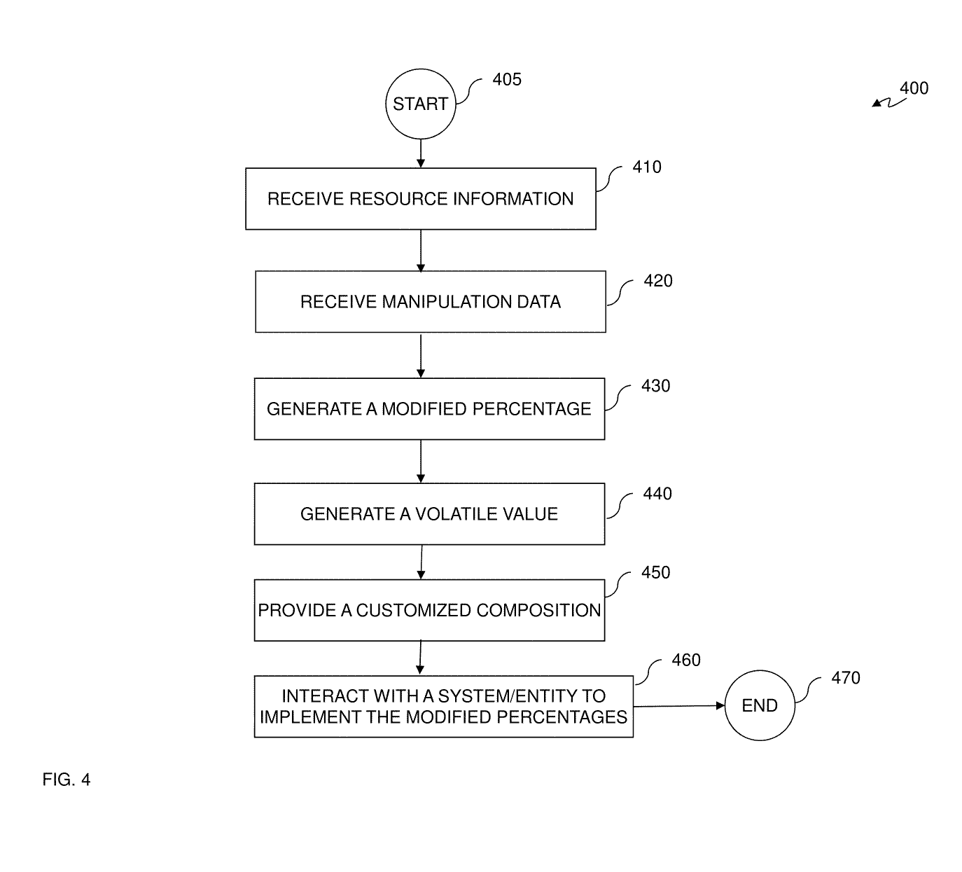

FIG. 4 illustrates an embodiment of a method for customizing established percentages of segments that constitute a collection of assets carried out according to the principles of the disclosure.

### DETAILED DESCRIPTION

The different segments that constitute a whole can be identified as a percentage of the whole. Accordingly, brakes can be identified as 15% of the total inventory and mufflers and wheels can be identified as 5% and 7%, respectively. Also, considering market indexes, oil and gas can make-up 10% of the index, transportation 8%, manufacturing 6%, etc. The percentages for the different segments can be set at fixed amounts as with recognized market indexes such as the Dow Jones Industrial Average (DJIA), Standard and Poor's (S&P) and Wishire. These percentages are typically fixed or at least provided as a standard ratio that can be employed. For example, a buyer knows the percentages of the various segments of the DJIA index when purchasing index shares. Likewise a store manager knows the standard ratio for the different parts that make-up the entire inventory.

This disclosure recognizes that the standard ratios are not always the best ratios; especially in view of known events or circumstances. Additionally, the disclosure recognizes the benefit of manipulating the ratios of some of the segments while staying within the boundaries of the whole. As such, the disclosure recognizes the ability to manage a universe of items by manipulating the ratios of the component parts.

Accordingly, this disclosure provides a tool that takes a population, or universe of items within a given population, that can be segmented or broken into their logical or associated parts and replicate or overlay that population such to allow for selective diversification or deviation of the parts from their standard ratio. This is done to provide for a different result via the adjusted segments than would normally be returned or used by the natural population or common users. Additionally, the tool can be used to enable measurement of both the population and the adjusted segments for comparison.

As a check, the disclosed tool can include a volatility risk measure that takes account of the historical range variations within the segments of the (1) normal and (2) replicated population and assigns a value to each given segment. Accordingly, a user can be alerted of the potential risk involved with one or multiple segment adjustments.

The tool can be used to manage items including items that have been grouped together. In one embodiment, the tool can also be used to manage the various items or assets that are within one or all of the groups. In some embodiments, the tool can be used to manage tangible products. In other embodiments, the tool can be used to manage products or stocks such as inventory management and stock management. The tool can be used to manage market indexes that allow investors to more closely correlate returns to the indices commonly employed as benchmarks.

In the area of finance, the disclosed tool addresses the need for investors to be able to invest in an appropriate and understandable array of securities that provide market correlated returns, at the same time providing investors the ability to diversify, while easily being able to adjust their investment exposure to obtain effective degrees of divergence from the broader market index. This in turn is designed to provide opportunities to outperform the standard market index. This is currently not possible through readily available index funds as they are structured to solely mirror a given index that has established sectors and recognized weights or percentages that are established by a managing or regulating authority. The disclosed tool provides a method, structure and ability, direct to investors in an easy to navigate and understandable manner, that allows them to manage an index by varying the ratio or weight of the segments or sectors of an index against the standard ratio or recognized percentages.

In some embodiments, the tool provides for the use of leverage within an account. In one aspect, this can be accomplished through a loan of securities comprising one sector to enable either cash or other form of funding to lever another sector. In another aspect, this can be accomplished through a simple funding either via securities loan or margin to lever the portfolio or sector.

FIG. 1 illustrates a diagram of an embodiment of a management system 100 constructed according to the principles of the disclosure. The management system 100 is configured to allow a user or client to manage a collection of assets by modifying recognized percentages or weights of segments that constitute the collection. Accordingly, a user can alter the recognized percentages of the segments to create a customized composition of the collection. The management system 100 can be employed to manage funds or investments associated with a market index. In other embodiments, the management system 100 can be employed to manage different collections of assets other than investments. For example, the management system 100 can be used to manage an inventory of products such as for a store, warehouse, etc.

The management system 100 includes a network 110, a client device 120, and an adjustment tool 140. The illustrated management system 100 also includes a news source 150, a management resource 160 and a bank 170.

The network 110 is configured to provide data communication between devices or components coupled thereto, such as the user devices and the content provider 130. The network 110 can be a conventional computer or communications network that allows data communication between devices, components, computers, etc., coupled thereto. The network 110 can provide wireless connections, wired connections or a combination thereof. In one embodiment, the network 110 is the Internet.

The user device 120 is a conventional device that is configured to communicate via the network 110. The user device 120 can be a communication device such as a smart phone, a tablet, a pad, a laptop, a desktop, a wearable device or another device capable of interfacing with a user.

The vendor 130 is an entity or source of the collection of assets. Thus, the vendor 130 can be a source of an index such as the DJIA. In other embodiments, the vendor 130 is the source of an inventory. For example, the vendor 130 can be a computer system that includes an inventory for a store, house, dealership, etc. In some embodiments, the vendor 130 is game website wherein the data or collection of assets that are used is part of a game or instructional tool.

The adjustment tool 140 is configured to allow a user to manage a collection of assets by customizing the recognized percentages or weights of individual segments that makeup or constitute the collection. The adjustment tool 140 or at least a portion thereof can be implemented on a server to provide a web-based tool for managing a collection of assets. As such, in one embodiment, the adjustment tool 140 is implemented on a server that includes the necessary logic and memory to perform the functions disclosed herein. Accordingly, the adjustment tool 140 can be a website hosted on a web server or servers and accessible via the World Wide Web. A Uniform Resource Locator (URL) can be used to access the various webpages thereof. In some embodiments, a subscription or registry is required for access to the adjustment tool 140.

In one embodiment the adjustment tool 140 includes an interface and a decision engine (not illustrated). The interface is configured to receive manipulation data associated with at least one of the multiple segments that form the collection of assets. The interface can be provided to the user device 120 to allow interaction between a user and the adjustment tool 140. In one embodiment, the interface can provide sliders that are moved by the user to generate the manipulation data. In other embodiments, other conventional input devices can be used. In one embodiment, the interface is configured to display the multiple segments, the corresponding recognized percentages, a modified percentage or percentages and the sliders. FIG. 3 illustrates an embodiment of an interface for use with managing a collection of funds.

The multiple segments constitute the collection according to recognized or established percentages. The decision engine receives the manipulation data from the interface and generates a modified percentage of at least one of the multiple segments based on the manipulation data. The modified percentage differs from the recognized percentage established for the particular segment. As such, a user can employ the adjustment tool 140 to create a customized composition of the collection of assets and based thereon manage the collection.

In one embodiment, the deciding engine is further configured to receive resource information and provide the resource information to the interface for the user to employ to create the customized composition. The resource information is data corresponding to the different segments of the collection. For example, the data can be a news story warning of a war that could change the price of oil. The resource information can be obtained, for example, from the news source 150. One skilled in the art will understand that multiple news sources can be used to provided pertinent data.

In some embodiments, the decision engine is also configured to generate a volatility value for the modified percentage. The volatility value can be used to indicate a potential problem to the user regarding the modified percentage. The volatility value can be a volatility risk measure that considers the historical range of variations within the segments with respect to the recognized percentages and in some embodiments, past modified percentages. A volatility value can be assigned to each segment or modified percentage. Accordingly, a user can be alerted of the potential risk involved with one or multiple segment adjustments. An effective volatility risk measure can be in the form of mean and standard deviation of the component within given timeframes. This volatility risk measure can be further augmented by applying a risk measure provided by the user, or leveraged in order to achieve a specific volatility or beta objective. In some embodiments, the volatility value can be entered directly by a user, an advisor or another person managing the system or assisting the user.

In some embodiments, the adjustment tool 140 further includes an asset manager that is configured to interact with the decision engine to facilitate implementation of the modified percentage for the at least one of the multiple segments. The asset manager can be used to interact with a system, institution, company, business, etc., to effect the modified percentage. For example, the collection of assets can be a market index and the adjustment tool 140 can communicate with financial institutions, such as the bank 170, to implement or initiate the changes to the composition of the collection based on the modified percentage or percentages. The adjustment tool 140 can also interact with the management resource 160 to, for example, manage the movement of funds or money transactions necessary to effect the changes based on the modified percentage and implement the modified percentage.

The management resource 160 is an entity that interacts with the user and the adjustment tool 140 to assist in managing the collection of assets. In one embodiment, the management resource 160 is an investment firm. In another embodiment, the management resource 160 is a distribution company or inventory management company. In some embodiments, the management resource 160 is a record keeper, a distributor or an agent who represents a client.

The management resource 160, for example, can be an investment firm that assists the user in market transactions based on the modified percentages. Additionally, the management resource 160 can be a record keeper that aggregates multiple individual client trades and provide a net cash and share flow to the fund.

FIG. 2 illustrates a block diagram of an embodiment of an adjustment tool 200 constructed according to the principles of the disclosure. The adjustment tool 200 or at least a portion thereof can be embodied as a series of operating instructions stored on a non-transitory computer-readable medium that direct the operation of a processor when initiated. The adjustment tool 200 can be stored on a single computer or on multiple computers. The various components of the adjustment tool 200 can communicate via wireless or wired conventional connections. A portion of the adjustment tool 200 can be located on a server and other portions of the adjustment tool 200 can be located on a computing device or devices that are connected to the server via a network or networks. In some embodiments, the adjustment tool 200 can be implemented using cloud computing. The adjustment tool 200 is configured to perform the various functions disclosed herein. In one embodiment, at least a portion of the adjustment tool 200 is a computer program product. The adjustment tool 200 includes an interface 210, a decision engine 220 and an asset manager 230.

The interface 210 is configured to visually provide information about assets to a user and to receive input from a user for manipulation of the provided information. In some embodiments, the interface 210 is also configured to allow audio manipulation by the user and audio verification of changes to the user. In one embodiment, the interface 210 is configured to allow manipulation of the information via sliders. FIG. 3 provides an example of an interface configured to manipulate stocks. The interface 210 can also be used to provide and manipulate other types of assets including inventories of different items that range, for example, from an individual's groceries at home to an inventory of cars at a car dealership. In one embodiment the interface 210 provides the information to a user via a computer screen or display and receives input via input devices such as a keyboard, mouse, stylis, microphone, touch screen, keypad or other types of input devices. The interface 210 can be provided on a user device such as the user device 120 in FIG. 1. As such, a display of the user device can be used for the interface 210.

The decision engine 220 is configured to interact with the interface 210 and perform the various manipulations initiated thereby. The decision engine 220 communicates with the interface 210 and includes the necessary logic to implement changes initiated by the interface 210. For example, a slider may be moved on the interface 210 that corresponds to a change in the percentage of an index fund. The decision engine 220 receives a signal or data indicating the change and causes the change to take place. In some embodiments, the decision engine 220 is configured to interact directly with various systems that implement the desired change. The decision engine 220 can also be pre-set by the client or user to take action when predefined thresholds are met. In other embodiments, the decision engine 220 interacts with a management component, such as the asset manager 230, that effects the change.

In some embodiments the decision engine 220 receives information from resources that can be provided to the interface 210 to assist a user in making investment changes or inventory changes. For example, a weather update may indicate a major storm in an area and a store manager or owner can alter the established percentage of roofing material in the area's stores to be prepared. This can be especially helpful when an owner is trying to maintain a fixed amount of value for the whole inventory. As such, recognized percentages of an inventory can be altered while staying within or close to the fixed inventory value. In addition to a weather website, the resources can be news agencies, investment reports, etc. This information can be used by the user to customize the composition of the collection of assets.

The asset manager 230 is configured to interact with the decision engine 220 and cause the desired changes to occur. As such, the asset manager 230 includes the necessary logic to communicate with the necessary systems to implement the desired changes. In some embodiments, these changes may be directed to occur once a day such as the end of a business day. In other embodiments, the changes can directed to occur multiple times throughout a day. In some embodiments, implementation of changes may occur at determined time intervals. The asset manager 230 can also be configured to provide feedback to the user as a result of their selections. The feedback can be via generated reports that provide information to the user as to the results of their selections and the impacts on the value of the total. The feedback and tracking of changes can be provided to the user via the interface 210.

The asset manager 230 can be configured to interact with different systems to implement the changes. Considering a financial application, the asset manager 230 can communicate with an investment computer program to implement changes. The computer programs may be proprietary systems. The asset manager 230 may also communicate with various money funds or banks to determine if there is sufficient capital to make the necessary changes. Leveraging may be allowed to fund the various changes. A vendor, such as an investment firm, can be used to assist in leveraging funds for customizing the composition of assets.

In some embodiments, the interface 210 can provide an acceptable range at which the segments can be altered. Accordingly, a limited or suggested range of change is provided for a user to employ to assist in altering the segments. This can include negative values for the segments. For example, a financial sector can be allowed to go negative to effect a “short” in which, if the sector value declines, the value of the “short” increases. Determination of the range can be made by the user, a financial advisor or a combination thereof.

The systems in which the asset manager 230 communicates to implement changes can vary depending on the application. Consider for example a warehouse of car parts. The asset manager 230 may communicate with an inventory system to effect the desired changes. In some embodiments, the asset manager 230 is configured to effect the desired changes itself. As such, it would be the inventory system in this example. In other embodiments, the asset manager 230 and the deciding engine 120 may be implemented as a single component of the adjusting tool 100.

FIG. 2 provides an example of an adjustment tool 200 constructed according to the principles of the disclosure. FIG. 3 illustrates an embodiment of an interface 300 constructed according to the principles of the disclosure. The interface 300 is for the embodiment in which an adjustment tool can be employed with fund management. The interface 300 is a graphical user interface that can be provided on a user device to provide information to and receive inputs from the user. The interface 300 is an example particularly directed to managing the funds with respect to the DJIA. As such, the recognized percentages in this embodiment correspond to the sector weights established for the DJIA and the segments correspond to the established sectors for the DJIA. One skilled in the art will understand that a similar interface can be used with another collection of funds or assembly of component parts that can be construed within a predefined whole. Accordingly, the various identified column headings can differ for other embodiments.

The interface 300 includes multiple columns and rows. The first row is a header row 301 that identifies each of the columns. Each entry of the header row 301 is discussed below. The remaining rows correspond to the various established sectors of the DJIA and include entries or data for each of the columns. One skilled in the art will understand that all of the sectors of the DJIA are not illustrated in FIG. 3 but that the interface 300 is applicable for all of the sectors.

The interface 300 is also divided into two sections. The first section, the standard section 303, corresponds to the recognized DJIA sectors and illustrates recognized composition of the DJIA. The standard section 303 is considered the norm and is provided to the general public. The second section, the customized section 305, corresponds to the customized composition of the DJIA of a user. The customized section 305 reflects the modified percentages input by a user. The customized section 305 also provides information that reflects changes to recognized composition of the DJIA according to the customized composition.

The standard section 303 includes the following columns: sector name 310, sector weight 315, daily sector return 320, contribution to index return 325 and index impact 330. The sector name 310 includes the various recognized sectors of the DJIA. The sector weight 315 is provided as a percentage and is the sum of the prices for the securities in the sector, divided by the total of the prices for the securities in the DJIA index. The daily sector return 320 is presented as a percentage that is generated by calculating the difference in the current price (i.e., today's price) of the sector and the prior price (i.e., yesterday's price), divided by the change in the total DJIA index. The contribution to index return 325 is provided as a percentage that is calculated by taking the DJIA index impact divided by the total point change for that day. The index impact 330 represents the current price for the sector, minus the prior price for the sector, divided by the DOW divisor or index or population measure.

The customized section 305 includes the following columns: sliders 340, selected sector weighting 345, variances to index weight 350, shares, 355, market value 360 and contribution to total return 365. The sliders 340 are configured to generate manipulation data in response to being moved by a user. The selected sector weighting 345 reflects the modified percentage or weight of the sector in response to the manipulation of the sliders 340. For example, a user generates manipulation data by moving the sliders 340. The sector weight 315 is modified based on the manipulation data to generate the selected sector weighting 345. In one embodiment a decision engine described herein can generate the selected sector weighting 345 based on the manipulation data input via the sliders 340. The variances to index weight 350 is provided as a percentage that is calculated by taking the selected sector weight and subtracting the sector weight 315. In some embodiments, the variances to index weight 350 can be used as a volatility value. Additionally, in some embodiments range of values are provided within which the weights can be set.

The shares 355 represent the number of shares that a user holds for a particular sector according to the selected sector weight 345. The market value 360 provides the market value, e.g., the most recent market value, for the corresponding sector. The market value 360 can be obtained via an external system, vendor or resource. In one embodiment, an asset manager is configured to obtain the market value 360.

The contribution to total return 365 is a calculated field that indicates a sector's contribution to the return of a user's portfolio. In one embodiment, the contribution to total return 365 is calculated by taking the increase in value of the sector with respect to the selected sector weight 345 and factor this by the total market value of the DJIA index to arrive at a contributing percentage for the sector.

The interface 300 also includes a column of action buttons 370 that are used to effect changes within the data ranges. In one embodiment, the action buttons 370 are configured to recalculate the columns of the customized selections 305 in response to manipulation of sliders 340.

Turning now to FIG. 4, an embodiment of a method for customizing established percentages of segments that constitute a collection of assets is illustrated. At least a portion of the method 400 can be performed by an adjustment tool as disclosed herein. A computing device may include the necessary logic circuitry to carry out the method 400. In one embodiment, the method 400 or at least a portion thereof may be embodied as a series of operating instructions that are stored on a non-transitory computer readable medium and used to direct the operation of a processor when initiated thereby. The method 400 begins in a step 405.

In a step 410, resource information corresponding to at least one of the segments is received. The resource information can be received by an adjustment tool.

Manipulation data associated with at least one of the segments is received in a step 420 of the method 400. The manipulation data can be received via a user interface such as an interface of an adjustment tool. The manipulation data can be received via user input from a slider of a user interface, or via direct entry into a given cell of the user interface to effect the desired value.

In a step 430, a modified percentage for at least one of the segments is generated according to the manipulation data. The modified percentage differs from an established percentage of the at least one. The modified percentage can be generated from the manipulation data. A modified percentage for multiple segments can be generated from the manipulation data. In some embodiments, a decision engine of an adjustment tool is configured to generate the modified percentage of one segment based on the manipulation data associated with a different segment.

In a step 440, a volatility value based on the modified percentage and the established percentage is generated. In some embodiments, the modified percentage is altered according to the volatility value.

A customized composition of the collection according to the modified percentage is provided in a step 450. In a step 460, interacting with a system or an entity is performed to implement the modified percentage. The system can be a computer system that modifies an inventory of products or funds. In some embodiments, the entity is an investment firm that performs the necessary transactions according to the customized composition. The method 400 ends in a step 470.

The disclosure provides managing and/or manipulating data within a given population that can be defined or aggregated by a recognized or established construct to establish the population and its component parts. A portion of the above-described apparatus, systems or methods may be embodied in or performed by various, such as conventional, digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

1. An adjustment tool for managing a collection of assets, comprising:
an interface configured to receive manipulation data associated with at least one of multiple segments that form said collection, wherein said multiple segments constitute said collection according to established percentages; and
a decision engine configured to generate a modified percentage of said at least one of said multiple segments based on said manipulation data, wherein said modified percentage differs from an established percentage of said at least one.

2. The adjustment tool as recited in claim 1 wherein said deciding engine is further configured to receive resource information and provide said resource information to said interface, wherein said resource information is data corresponding to said at least one of said multiple segments.

3. The adjustment tool as recited in claim 1 wherein said interface is configured to receive said manipulation data via a slider.

4. The adjustment tool as recited in claim 1 wherein said decision engine is further configured to generate a volatility value for said modified percentage.

5. The adjustment tool as recited in claim 1 wherein said collection is a market index.

6. The adjustment tool as recited in claim 1 further comprising an asset manager configured to interact with said decision engine to facilitate implementation of said modified percentage for said at least one of said multiple segments.

7. The adjustment tool as recited in claim 6 wherein said asset manager is configured to interact with a system external to said adjustment tool to effect said modified percentage.

8. The adjustment tool as recited in claim 7 wherein said system is a financial institution selected from the group consisting of:
an investment fund manager,
a money fund manager,
a record keeper,
a registered agent,
a company treasury and
a bank.

9. The adjustment tool as recited in claim 7 wherein said collection is a market index and said asset manager is further configured to interact with said system to obtain funding to effect said modified percentage.

10. The adjustment tool as recited in claim 1 wherein said interface is configured to display said multiple segments, said corresponding established percentages, said modified percentage and a slider for each of said multiple segments that are employed to customize said established percentages to modified percentages.

11. A method of customizing established percentages of segments that constitute a collection of assets, comprising:
receiving manipulation data associated with at least one of said segments;
generating a modified percentage for said at least one of said segments according to said manipulation data, wherein said modified percentage differs from an established percentage of said at least one; and
customizing a composition of said collection according to said modified percentage.

12. The method as recited in claim 11 further comprising receiving resource information corresponding to said at least one of said segments.

13. The method as recited in claim 11 further comprising generating a volatility value based on said modified percentage and said established percentage.

14. The method as recited in claim 11 further comprising altering said modified percentage according to said volatility value.

15. The method as recited in claim 11 further comprising interacting with a financial institution to implement said modified percentage.

16. The method as recited in claim 11 further comprising providing a visual display of said segments, said corresponding established percentages, said modified percentage and a slider for each of said segments that are employed to customize said established percentages to modified percentages.

17. The method as recited in claim 16 wherein said manipulation data is received via said slider corresponding to said at least one segment.

18. An adjustment tool for managing a market index, comprising:
an interface configured to receive manipulation data associated with a sector of said market index; and
a decision engine configured to generate a customized composition of said market index by modifying a recognized weight of said sector according to said manipulation data, wherein said customized composition differs from a recognized composition of said market index.

19. The adjustment tool as recited in claim 18 further comprising an asset manager configured to interact with a financial institution to implement said customized composition.

20. The adjustment tool as recited in claim 18 wherein said decision engine is further configured to generate a volatility value based on said customized composition and said recognized composition.
